(19) United States
(12) Patent Application Publication
(10) Pub. No.: US 2007/0169142 A1
(43) Pub. Date: Jul. 19, 2007

(54) Using a presence status in a media-on-demand system

(75) Inventors: Arjan Claassen, Eindhoven (NL); David Peter Louis Simons, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,886

(22) PCT Filed: Dec. 23, 2004
(86) PCT No.: PCT/IB04/52914

§ 371 Date: Jun. 28, 2006

(30) Foreign Application Priority Data
Jan. 9, 2004 (EP) 04100045.6

(51) Int. Cl. H04N 7/16; H04H 9/00; H04N 7/173

(52) U.S. Cl. 725/10; 725/86; 725/9

(57) ABSTRACT

The present invention relates to a method for a media-on-demand server of handling streaming of media based on media requests received from user operated clients, wherein said server receives media requests from a user operated client and streams said media to said user operated client, wherein the handling of streaming comprises using a presence service adapted for determining the presence status of said user operating said client and only streaming user requested media if said user has a predefined presence status. Thereby it is possible at the server to check the presence status of the user before streaming media requested by the user, and it can e.g. be avoided that a user not being present at the client receives the stream of media, without being able to enjoy the requested media

The present invention relates to a method for a media-on-demand server of handling streaming of media based on media requests received from user operated clients. The invention further relates to a media-on-demand server for handling streaming of media based on media requests received from a user operated client. The invention further relates to a user operated client to be used for requesting media to be streamed by a media-on-demand server.

The rapid publication of media content has been sought throughout human history. Publishers strive to deliver media content faster to larger audiences. As used herein, the term “media” or “content” refers to any information, including audio, video, data, ideas, images, stories, sound, text, or other information, that is perceived by one or more human senses.

The digital representation of media content combined with computing and networking technologies now provide a powerful way to publish. According to this new mode of publishing, networking technology permits the delivery of digitized media content over a network to end user computers. Communication protocols define how the digitized media content is exchanged over the network. A media player runs on the end user computer to allow the user to play or otherwise experience the media content.

In media-on-demand systems a user can use a client connected to a network (e.g. Internet, intranet, LAN, home network, . . . ) to request or order a certain piece of content at a service provider referred to as the media-on-demand server. Based on this requests the server transmits the requested content to the client, and the content is ready to be played back, e.g. activating a viewer for viewing requested text, playing back audio using an audio player or playing back video using a video player.

As an example an interactive radio station media-on-demand server may allow users to request songs from the server's archive, which are then queued to be streamed in the near future. Another example is a video-on-demand system, where a user may order a movie from the archive of the video-on-demand server, the movie is then shown to the user in the next time slot (e.g. within the next half hour).

There is a chance that at the actual time of streaming the content the user may have left and is therefore not present at the client device being used for rendering the received content. In these cases it is often at best possible for the user to cancel the request before leaving the device. The user might forget to perform this cancellation, or a cancellation might not even be possible. In this case the content is played back from the server, even though the user is not present and therefore not able to enjoy the content. A further problem is that the user is often charged for the media-on-demand services, and the user then risks paying for something, which he is not able to enjoy.

It is therefore an object to obtain a method for solving the above mentioned problem.

This is obtained by a method for a media-on-demand server of handling streaming of media based on media requests received from user operated clients, wherein said server receives media requests from a user operated client and streams playback enabled media to said user operated client, wherein the handling of streaming comprises using a presence service adapted for determining the presence status of said user operating said client, and only streaming user requested media if said user has a predefined presence status.

The presence status is information about availability of the user such as:
a) “I am not here”;
b) “I am in a specific position”;
c) “I am here”, etc.

Thereby it is possible at the server to check the presence status of the user before streaming media requested by the user, and it can e.g. be avoided that a user not being present at the client receives the streamed media without being able to enjoy the requested media. This could e.g. be further advantageously used to charge a user for the media only if the user was present at the streaming time. Such usage would require high security of the presence service. Another usage could be to only stream media when the presence status indicates that the user is present in the AV room, wherein the sound of audio is reproduced or the image of a video is reproduced.

A media-on-demand server could e.g. be an Internet (or Intranet) radio server connected to user operated client via the Internet. The server comprises a library with different songs, and the user is, via the client, able to search in the song library and request a song to be streamed via a browser application in the client accessing the library. The client comprises the browser application, and further comprises an audio application (e.g. a MP3 player) adapted for rendering streamed songs received from the server on AV equipment connected to the client, such as a separate monitor and/or a set of speakers. The client and server further comprise a presence service enabling the server to obtain the presence status of the user from the client. This presence status could e.g. be kept up-to-date by the user, or automatically by monitoring the user activity (e.g. keystrokes or mouse movements).

In a specific embodiment the method comprises storing said media requests received by said user operated clients in a playback list, said list indicating the order in which the media requests are to be streamed, and wherein a media request is kept in the playback list and only streamed when said user has said predefined presence status.

Thereby the media will NOT be streamed when the user does NOT have the predefined presence status, but as soon as it changes to the predefined presence status (e.g. “I am here”), the media is streamed. Thereby especially if the user has paid for the media, the media-on-demand system becomes more attractive for the user, since it is ensured that the user is able to enjoy the media that the user paid for.

In another embodiment the method comprises storing said media requests received by said user operated clients in a playback list, said list indicating media requests to be streamed at predefined time slots, wherein a media request is only streamed at a predefined time slot, when said user has said predefined presence status in that time slot.

Thereby a media-on-demand system using timeslots only performs the streaming of media in a time slot if the user has a predefined presence status, e.g. the status being (“I am available” or “I am in the AV room”) in that time slot.

In an embodiment the media request is cancelled by removing said media request from said playback list if said user does not have said predefined presence status. Thereby media requests which are not streamed due to the different presence status of the user are deleted from the list, ensuring that the entries are kept at a minimum.

In an embodiment the predefined presence status indicates that the user is present at the client. This is an advantage since the devices for reproducing the video or audio are often integrated in the client. The client could e.g. be a PC with an Internet connection comprising speakers.

The invention further relates to a media-on-demand server for handling streaming of media based on media requests received from a user operated client, wherein said server comprises:

means for receiving media requests from said user operated client,

means for streaming media to a rendering system operated by said user,

means for determining the presence status of said user operating said client.

In a specific embodiment said server further comprises:

means for storing said media requests received by said user operated clients in a playback list until said media has been streamed.

In an embodiment said means for determining the presence status of said user operating said client comprises a presence status client adapted for receiving a user specific presence status from a presence status server connected to said media-on-demand server.

The presence server could e.g. be a XMMP (XML presence protocol) server, and there are two presence client applications, on respectively the user operated client device and the media-on-demand server, which are XMMP clients for respectively updating the user presence status to the presence server and retrieving the latest presence status from the presence server.

The invention further relates to a user operated client to be used for requesting media to be streamed by a media-on-demand server, wherein said client comprises:

means for transmitting a media request to said server,

means for indicating a presence status of said user to said server,

means for receiving and rendering media from said server, wherein said server is adapted for serving user requested media if said indicated presence status is a predefined presence status.

In a specific embodiment said means for indicating a presence status of said user operating said client comprises a status client adapted for transmitting user specific presence status to a presence status server connected to said user operated client.

In the following, the preferred embodiments of the invention will be described referring to the figures, where

FIG. 1 illustrates a media-on-demand system according to the present invention,

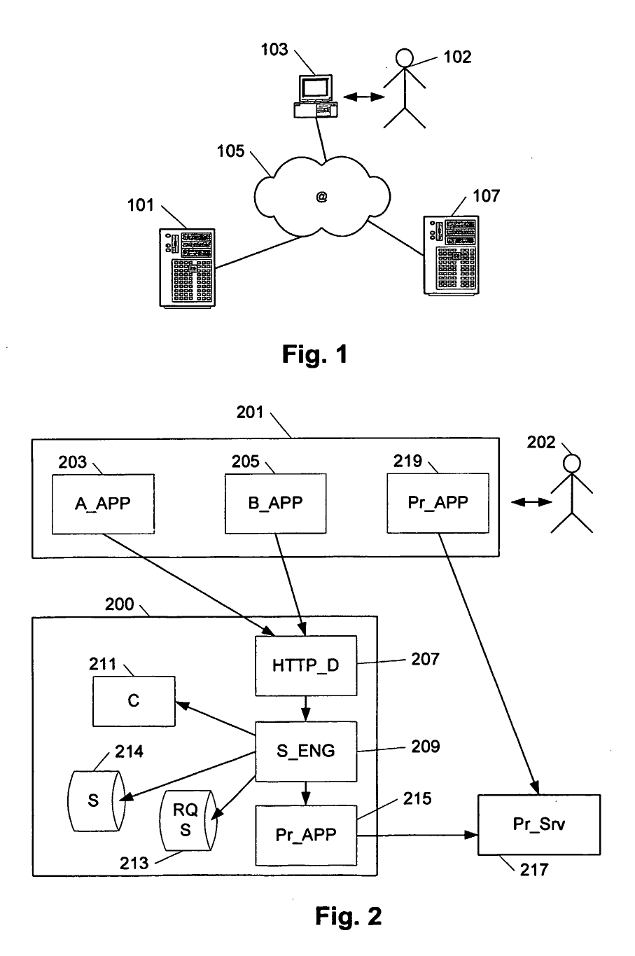

FIG. 2 illustrates a schematic view of a media-on-demand system according to the present invention,

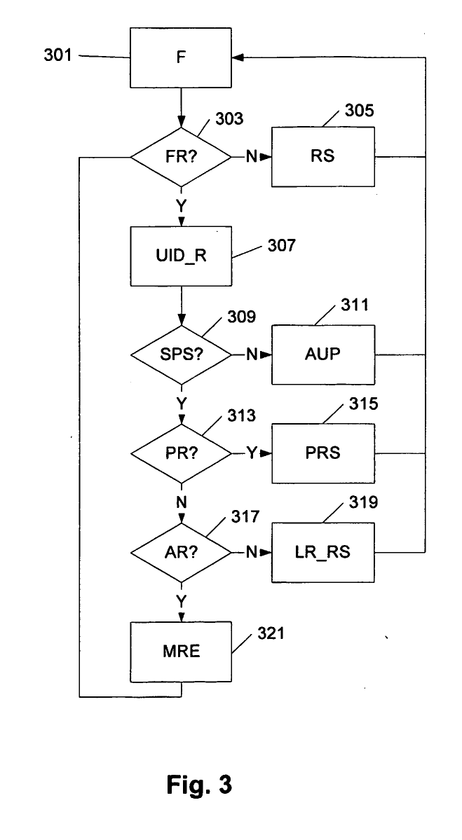

FIG. 3 illustrates a method of handling media-on-demand according to the present invention.

In FIG. 1 a media-on-demand system according to the present invention is illustrated. The system comprises a media-on-demand server 101 and a client 103 operated by a user 102 and connected to the server 101 via a communication network, in the present example being the Internet 105. The client accesses the server 101 via the network connection, and thereby the client can send a media request to the server 101 requesting media to be streamed to the client 103. The client 103 could then comprise build in functionality for rendering the received streamed media, such as speakers, video screen etc, alternatively the client could be connected to an external television or stereo through which the media is rendered. Before starting to stream the requested media to the user operated client 103, the presence of the user is checked. The presence check is performed using a presence server 107, and the associated presence protocol which could be connected to both the client and the media-on-demand server. The presence server and protocol share information about the user's presence status, e.g. is the user present at the client at the time of streaming. This check is performed before streaming the media, and only if the user is present, the streaming is performed; otherwise the streaming could be skipped or put on hold.

In FIG. 2 a more specific example is given, where an internet radio server 200 enables users to queue songs via a HTML and Scripting interface keeping track of the user's identity through a HTTP-daemon authorization scheme. In this example the user is referred to as a listener 202 operating a client 201. On the client 201 an audio application (A_APP) (e.g. Winamp) is running, and this audio application is adapted for receiving the Internet Radio audio stream via HTTP streaming from the Internet radio server (e.g. port 8000). Also, the listener can open a web browser 205, to obtain a search and request interface through which the songs can be requested (different URL, e.g. port 80 on the same server).

The client 201 communicates with the server 200 via a HTTP Daemon (HTTP_D) 207 and associated HTTP protocol. The HTTP Daemon is also used to transport the media stream to the audio application 203 on the client 201. The code (C) 211 is executed by a scripting engine 209 and contains the business logic to determine, which songs are to be streamed and when they are to be streamed. Based on the list of requested songs 213 (RQ S), plus a randomization algorithm in case of no song requests, songs are read from the song database (S) 214 and streamed to the audio applications of the connected clients.

The server further comprises a presence protocol application 215 e.g. XMMP client. This client application can connect to a presence server or a XMMP server 217 and subscribe to the presence status of the listeners 202, for which the XMMP username is known. The XMMP username is mapped to the user's identity via the HTTP_deamon request. If the listener decides to allow the Internet radio server to see his/her status, the scripting engine 209 can dynamically take this status into account when handling song requests of that listener. The XMMP client application 215 would be linked into the scripting code to allow the script to check—when needed—the presence status of a certain listener. The presence server is also connected to a presence application 219 at the client 201, and through this presence application 219 the listener ensures that the presence status at the presence server is kept up-to-date.

The presence status could e.g. be obtained by subscribing to a Presence Protocol service (e.g. Jabber XMMP, MSN Messenger, Yahoo Messenger, ICQ, etc.). Using the location information from the web browser 205 and the mapping to the username in these presence protocol services, the media-on-demand server could have knowledge of the user's address in the presence protocol service and use the address to request the listener for subscription to his roster, and with that to his/her presence status (Available, Away, Extended Away, etc.).

In FIG. 3 a block diagram illustrates an algorithm for selecting the next song to be streamed by a radio-on-demand server according to the present invention. The radio is adapted for continuously (24 H and 7 days a week) streaming audio data to the audio applications on the connected clients. The streaming is performed based on a request list identifying requested songs. In 301 the server has finished streaming a song (F). Then, in 303 it is determined whether there are further requests (FR) in the request list, and if there are no further requests, then in 305 a random song (RS) from the song database is streamed, and the algorithm is restarted. If there are further songs in the request queue, then in 307 the ID of the user that has requested the next song (UID_R) is determined. In 309 it is, based on the user ID, determined whether the user has subscribed to the presence status service (SPS) e.g. by supplying his/her presence status address, and if the user has not subscribed to the presence service 311 it is assumed that the user is present (AUP), and the song is streamed and the algorithm is restarted. If the user has subscribed to the present status service, then in 313 the presence status is determined, and if the status indicates that the user is available, then in 315 the song requested by the user is streamed (PRS), and the algorithm is restarted. If the presence status indicates that the user is not present, then in 317 it is determined whether there is another request (AR) in the request list, and if this is not the case, then in 319 the request is left at the same position in the request list, and a random song from the song database is streamed (LR_RS), and the algorithm is restarted. In 321, if there is another request, the request of the user not available is placed in the bottom of the request list, and the algorithm returns to 303, wherein in 303 it is determined whether there are further requests (FR) in the request list that were not inspected recently, and if there are no further requests, then in 305 a random song (RS) from the song database is streamed, and the algorithm is restarted. If there are further songs in the request queue, then in 307 the ID of the user that has requested the next song (UID_R) is determined. Then the algorithm continues from here as described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for a media-on-demand server of handling streaming of media based on at least one media request received from at least one user operated client, wherein said server receives at least one media request from a particular user operated client and streams media to said user operated client, wherein the handling of streaming comprises using a presence service adapted for determining a presence status of a user operating said client and only streaming user-requested media if said user has a predefined presence status.

2. A method according to claim 1, wherein said method comprises storing said media requests received by said user operated clients in a playback list, said list indicating the order in which the media requests are to be streamed, and wherein a media request is kept in the playback list and only streamed if said user has said predefined presence status.

3. A method according to claim 1, wherein said method comprises storing said media requests received by said user operated clients in a playback list, said list indicating media requests to be streamed at predefined time slots, wherein a media request is only streamed at a predefined time slot, if said user has said predefined presence status.

4. A method according to claim 2, wherein the media request is cancelled by removing said media request from said playback list if said user does not have said predefined presence status.

5. A method according to claim 1, wherein the predefined presence status indicates that the user is present at the client.

6. A media-on-demand server for handling streaming of media based on at least one media request received from at least one user operated client, wherein said server comprises:
means for receiving at least one media request from a particular user operated client,
means for streaming media to a rendering system operated by a user,
means for determining a presence status of said user operating said client.

7. A media on demand server according to claim 6, wherein said server further comprises:
means for storing said media requests received by said user operated clients in a playback list, until said media has been streamed.

8. A media on demand server according to claim 6, wherein said server further comprises:
means for streaming user requested media if said presence status of said user is a predefined presence status.

9. A media-on-demand server according to claim 6, wherein said means for determining the presence status of said user operating said client comprises a presence status client adapted for receiving a user specific presence status from a presence status server connected to said media-on-demand server.

10. A user operated client to be used for requesting media to be streamed by a media-on-demand server, wherein said client comprises:
means for transmitting a media request to said server,
means for indicating a presence status of a user to said server,
means for receiving and rendering media from said server, wherein said server is adapted for streaming user requested media if said indicated presence status is a predefined presence status.

11. A user operated client according to claim 10, wherein said means for indicating a presence status of said user operating said client comprises client status adapted for transmitting user specific presence status to a presence status server connected to said client.
